(19) United States
(12) Patent Application Publication
(10) Pub. No.: US 2026/0342244 A1
(43) Pub. Date: Oct. 29, 2026

(54) Nonreciprocating DC Generator

(71) Applicant: Larry Wade Scruggs, Tampa, FL (US)

(72) Inventor: Larry Wade Scruggs, Tampa, FL (US)

(21) Appl. No.: 19/700,299

(22) Filed: Jun. 7, 2026

(51) Int. Cl. H02N 11/00

(52) U.S. Cl. CPC H02N 11/002

(57) ABSTRACT

A nonreciprocating DC generator constructed according to Faraday's Laws of Induction comprising a sealed, gas evacuated, non-ferrous hollow hoop with its exterior surface wrapped by a coil of wire terminating in leads for electrical connectivity, wherein the hoop encloses a magnetic element that is heavy enough to be held by gravity within the bottom portion of the hoop so that when the hoop is rotated in a substantially vertical plane by a prime mover the encoiled hoop moves past the gravitationally restrained magnetic element, thereby inducing a DC current in the coil that is harvestable by connected circuits and devices.

### PRIOR ART

There are numerous examples of reciprocating DC generators, a common one being the classic Faraday induction flashlight. U.S. Pat. No. 7,232,238 shows such a flashlight, the basic working components of which being a permanent magnet enclosed within a linear tube with the tube's exterior being wrapped by a wire to create an induction coil. Reciprocating movement of the device drives the magnet back and forth within the tube which induces a current in the coil for consumption by devices attached to terminal leads of the coil.

### BACKGROUND OF THE INVENTION

Faraday's Laws of Induction govern the background of this invention.

### SUMMARY OF THE INVENTION

An improvement on the Faraday shaker style reciprocating DC generator, the applicant's invention uses a substantially rigid non-ferrous hollow hoop being rotated in a substantially vertical plane by a prime mover, with the interior of the hoop providing a continuous void that allows a resident magnetic element to be restrained by gravity in the bottom area of the hoop as the encoiled hoop rotates by, thusly eliminating the need for reciprocation to induce DC current in the coil.

### BRIEF DESCRIPTION OF DRAWINGS

FIG. 1 features the nonreciprocating DC generator 11, including the induction coil 6, the hoop connector 2, the evacuation valve 5, and coil terminal leads 7. FIG. 1 also shows a bounding box that indicates the general location of the generator's gravitational home 15.

FIG. 2 depicts a variant of the magnetic element 3, consisting of permanent magnets 8, cushioning pads 9, and ferrous weights 10.

FIG. 3 shows the hollow hoop 1 of the generator, the hoop connector 2, the magnetic element 3, a virtual cutout to expose the element in the gravitational home of the hoop 4, and the evacuation valve 5.

FIG. 4 depicts a variant of the supportive body 12 attached to a prime mover 16 by mounting straps 13, LEDs 14, coil terminal leads 7 connecting to an illuminating strip 17 which is integrated with the prime mover 16, and the prime mover axis 18.

FIG. 5 is a cross section of the bottom of the hollow hoop 1, the magnetic element 3, the induction coil 6, an terminal lead 7, the supportive body 12, the evacuation valve 19, and the hoop void 21.

FIG. 6 illustrates the hollow hoop 1, the hoop's exterior surface 20, and the hoop void 21.

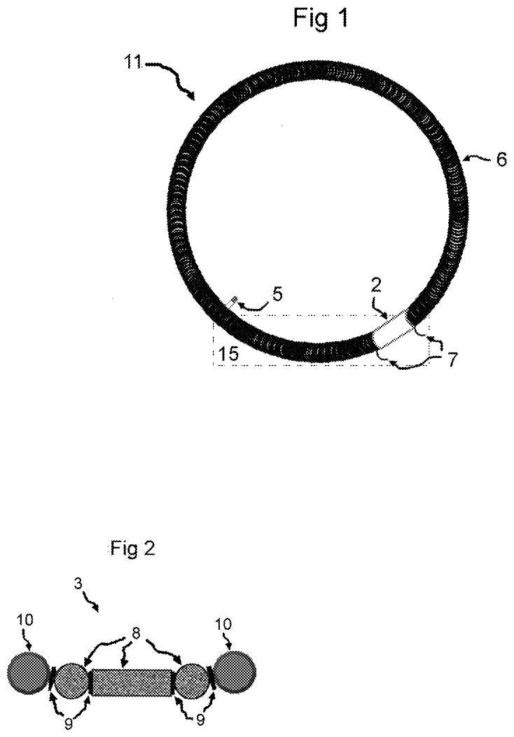

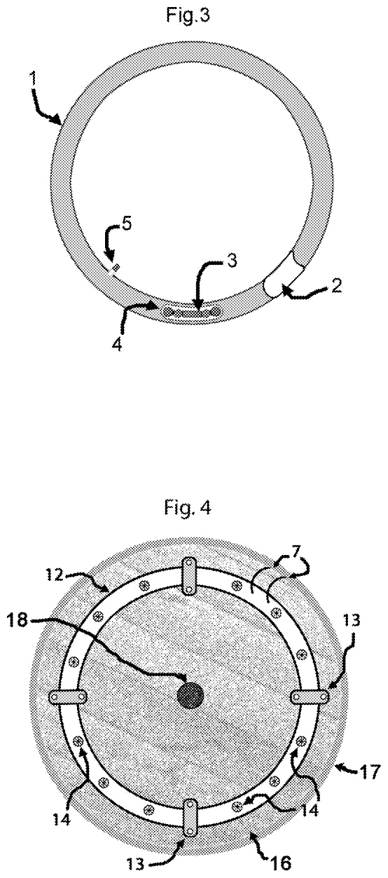

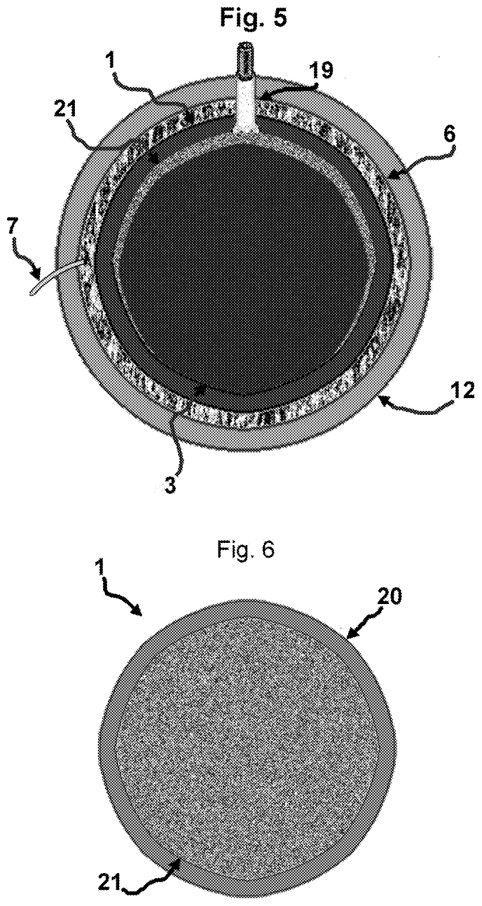

### DETAILED DESCRIPTION OF THE INVENTION

Assembled in accordance with Faraday's Laws of Induction, the nonreciprocating DC generator will provide the option to generate electricity with numerous rotating objects. Vehicle wheels, water wheels, windmills, machine elements, etc., will become prime movers for producing power.

Constructed according to those skilled in the arts of magnetic induction, friction reduction, and gravity, the proposed nonreciprocating generator is a logical improvement on the Faraday induction coil generator. The proposed generator is based upon a hollow hoop, wherein the hoop is tightly wrapped with a length of induction wire to create an induction coil having lead terminals. Enclosed within the hoop is a magnetic element comprising of one or more permanent magnets. One or more ferrous weights may be necessary for the magnetic element to be heavy enough to be properly restrained by gravity in the gravitational home of the hoop during operation. To reduce wear and friction between components, non-ferrous cushioning pads may be positioned between components of the element as magnetic attraction holds the element's components together. It is understood by the applicant that components of the magnetic element may be unified by another method such as encapsulation by a substantially rigid low friction substance in which case the weights need not be ferrous. The applicant recognizes that those skilled in the art of magnetics will devise alternate configurations of the magnetic element. It is also understood that the resulting nonreciprocating generator will occupy space within a supportive housing that may be attachable and detachable from the prime mover or an integral part of the prime mover, the design aspects of which are not addressed by this invention.

Operationally, when force provided by a prime mover drives the hoop rotationally in an substantially vertical plane, resulting movement of the induction coil past the gravitationally restrained magnetic element induces current in the coil which may be harvested via the terminal leads. Connected consumptive devices may be affixed to, or integrated parts of the supportive housing. Devices associated with the prime mover may be connected to an attached generator via the terminal leads.

The proposed invention also includes a hoop connector for assembly and disassembly of the hoop, and an evacuation valve to remove gases from the hoop as a method of reducing friction. The applicant recognizes that these features may be optional in the production and usage of the invention. It is also understood that various methods of friction reduction other than evacuation of gasses from the hoop will be involved with the composition of the generator.

With numerous possible applications and variables, the applicant anticipates that variations of design and usage of the proposed nonreciprocating DC generator will be many, and that all will be covered by the concept and simplicity of this invention.

I claim:

1. A nonreciprocating DC generator comprising:
a sealed non-ferrous hollow hoop having a continuous unobstructed internal void;
a valve for evacuating the void to reduce internal friction;
a magnetic element enclosed within the void;
a gravitational home for the magnetic element within the void;
an exterior surface of the hoop;
an induction coil tightly wrapped around the exterior surface of the hoop wherein the induction coil has terminal leads;
wherein a substantially vertical prime mover with an axis imparts a rotational movement to the encoiled hoop;
wherein gravity compels the magnetic element to remain relatively stationary in the gravitational home of the hoop as the imparted rotational movement provided by the prime mover propels the coil past the relatively stationary magnetic element residing in the gravitational home of the hoop, thereby inducing in the coil a DC current capable of being harvestable by DC devices via the terminal leads;
wherein the generator is enclosed within a supportive body, with the supportive body being attachable to or part of the prime mover, wherein the supportive body of the generator shares the axis of the prime mover so that the generator rotates in tandem with the prime mover;
wherein one or more DC current harvesting devices are affixed to or integrated with, the generator, the supportive body, or the prime mover.

2. The nonreciprocating DC generator of claim 1, wherein the generator has multiple induction coils.

3. The nonreciprocating DC generator of claim 1 with a hoop connector to facilitate assembly and disassembly of the hoop.

4. The nonreciprocating DC generator of claim 1 with other means of reducing internal friction.
